(19) United States
(12) Patent Application Publication
(10) Pub. No.: US 2022/0190314 A1
(43) Pub. Date: Jun. 16, 2022

(54) NEGATIVE ELECTRODE FOR NON-AQUEOUS ELECTROLYTE SECONDARY BATTERY AND NON-AQUEOUS ELECTROLYTE SECONDARY BATTERY

(71) Applicant: Panasonic Intellectual Property Management Co., Ltd., Osaka-shi, Osaka (JP)

(72) Inventors: Yohei Uchiyama, Hyogo (JP); Taisuke Asano, Hyogo (JP); Yosuke Sato, Osaka (JP); Masahiro Soga, Osaka (JP)

(73) Assignee: Panasonic Intellectual Property Management Co., Ltd., Osaka-shi, Osaka (JP)

(21) Appl. No.: 17/439,944

(22) PCT Filed: Mar. 11, 2020
(86) PCT No.: PCT/JP2020/010636

§ 371 Date: Sep. 16, 2021

(30) Foreign Application Priority Data
Mar. 19, 2019 (JP) 2019-051787

(51) Int. Cl. H01M 4/134; H01M 10/0567; H01M 10/0525; H01M 4/36

(52) U.S. Cl. CPC H01M 4/134; H01M 10/0567; H01M 2004/027; H01M 4/364; H01M 10/0525

(57) ABSTRACT

A negative electrode for a non-aqueous electrolyte secondary battery includes a negative electrode mixture comprising a negative electrode active material capable of electrochemically absorbing and releasing lithium ions, a negative electrode additive, and an acrylic resin. The negative electrode active material includes a silicon containing material. The Negative electrode additive includes at least silicon dioxide and a group 2 element oxide, and the group 2 element oxide includes at least one selected from the group consisting of BeO, MgO, CaO, SrO, BaO and RaO. The acrylic resin includes at least a (meth)acrylic acid salt unit. The content of the group 2 element oxide in the negative electrode additive is less than 20 mass % relative to a total amount of the negative electrode additive.

### TECHNICAL FIELD

The present invention relates to a negative electrode including a silicon containing material and a non-aqueous electrolyte secondary battery including the negative electrode.

### BACKGROUND ART

Non-aqueous electrolyte secondary batteries represented by a lithium-ion secondary battery includes a positive electrode, a negative electrode and a non-aqueous electrolyte. A negative electrode includes a negative electrode mixture containing a negative active material capable of electrochemically absorbing and releasing lithium ions. In order to increase the capacity of a battery, it has been studied to use a silicon containing material as a negative electrode active material. A non-aqueous electrolyte contains lithium salt. As the lithium salt, lithium hexafluorophosphate (LiPF₆) is widely used.

The components in the non-aqueous electrolyte may react with moisture in the battery to form hydrogen fluoride. Hydrogen fluoride tends to decompose the silicon containing material, and the cycle characteristics tend to decrease due to degradation and deterioration of the silicon containing material.

On the other hand, Patent Literature 1 proposes adding a glass powder containing silicon dioxide and an alkaline earth metal oxide to a negative electrode or the like in order to reduce hydrogen fluoride.

### CITATION LIST

### Patent Literature

[PTL 1] Japanese Laid-Open Patent Publication No. 2015-532762

### SUMMARY OF INVENTION

### Technical Problem

As a method of using the glass powder described in Patent Literature 1, it is conceivable to prepare a negative electrode using a negative electrode slurry including a negative electrode mixture including a silicon containing material and a glass powder dispersed in water. However, negative electrode slurries containing the glass powder are prone to shifting to basic property. In basic ambient, the silicon containing material may be dissolved and deteriorated, and the cycle characteristics may be deteriorated.

### Solution to Problem

In view of the above, one aspect of the present invention relates to a negative electrode for a secondary battery including a negative electrode mixture including a negative electrode active material capable of absorbing and releasing lithium ions, a negative electrode additive, and an acrylic resin, the negative electrode active material including a silicon containing material, the negative electrode additive including at least a silicon dioxide and a group 2 element oxide, the group 2 element oxide including at least one selected from the group consisting of BeO, MgO, CaO, SrO, BaO and RaO, the acrylic resin including at least a (meth)acrylic acid salt unit, the content of the group 2 element oxide in the negative electrode additive being less than 20 mass % relative to a total amount of the negative electrode additive.

Further, another aspect of the present invention relates to a non-aqueous electrolyte secondary battery including a positive electrode, a negative electrode and a non-aqueous electrolyte, wherein the negative electrode is the above negative electrode.

### Advantageous Effects of Invention

According to the present invention, it is possible to enhance the cycle characteristics of a non-aqueous electrolyte secondary battery including a negative electrode including a silicon containing material.

While the novel features of the invention are set forth in the appended claims, the invention relates both to configuration and content and will be better understood by the following detailed description taken in conjunction with other objects and features of the invention and collating the drawings.

### BRIEF DESCRIPTION OF DRAWINGS

FIG. 1 A schematic partially cut-away oblique view of a non-aqueous electrolyte secondary battery of one embodiment of the present invention.

### DESCRIPTION OF EMBODIMENTS

A negative electrode for a non-aqueous electrolyte secondary battery according to one embodiment of the present invention includes a negative electrode mixture, and the negative electrode mixture includes a negative electrode active material capable of electrochemically absorbing and releasing lithium ions, a negative electrode additive, and an acrylic resin. The negative electrode active material includes a silicon containing material. The negative electrode additive includes at least silicon dioxide and a group 2 element oxide. The group 2 element oxide includes at least one selected from the group consisting of BeO, MgO, CaO, SrO, BaO and RaO. The acrylic resin includes at least a (meth)acrylic acid salt unit. The content of the group 2 element oxide in the negative electrode additive is less than 20 mass % relative to the total amount of the negative electrode additive (100 mass %).

By including the above negative electrode additive in the negative electrode mixture, deterioration of the silicon containing material due to hydrogen fluoride generated during charging and discharging after manufacturing the battery is suppressed. Further, by adjusting the content of the group 2 element oxide in the negative electrode additive within the above range and also including the above acrylic resin in the negative electrode mixture, the shift of the negative electrode slurry to basic property due to the negative electrode additive is greatly suppressed. By suppressing the shift of the negative electrode slurry to basic property, the dissolution deterioration of the silicon containing material and the reduction of the cycle characteristics due to the deterioration are greatly suppressed.

### (Negative Electrode Additive)

The negative electrode additive includes at least silicon dioxide (SiO₂), and includes a group 2 element oxide containing at least one selected from the group consisting of BeO, MgO, CaO, SrO, BaO and RaO. When hydrogen fluoride is produced due to decomposition of the non-aqueous electrolyte associated with moisture in the battery, the hydrogen fluoride reacts with silicon dioxide and the group 2 element oxide in the negative electrode additive to produce fluoride. Since the amount of the hydrogen fluoride is thus reduced by the negative electrode additive, the dissolution deterioration of the silicon containing material is suppressed and the cycle characteristics is improved. For example, when BaO is used, a BaSiF₆ is produced. The negative electrode additive is used, for example, as a powdery glass including the silicon dioxide and the group 2 element oxide.

In the aforementioned negative electrode additive, the content of group 2 element oxide may be less than 20 mass % relative to the total amount of the negative electrode additive. In this case, since the negative electrode additive sufficiently absorbs hydrogen fluoride and the shift of the negative electrode slurry to basic property is suppressed, it is possible to reduce the dissolution deterioration of the silicon containing material. When the above acrylic resin is used together with the negative electrode additive containing a specified amount of the group 2 element oxide, the cycle characteristics are greatly improved.

The content of the group 2 element oxide in the negative electrode additive is, for example, 1 mass % or more and less than 20 mass %, preferably 3 mass % or more and 19.5 mass % or less, and more preferably 10 mass % or more and 19.5 mass % or less relative to the total amount of the negative electrode additive. When the content of the group 2 element oxide in the total amount of the negative electrode additive is 1 mass % or more, hydrogen fluoride is sufficiently absorbed by the negative electrode additive. When the content of the group 2 element oxide in the total amount of the negative electrode additive is less than 20 mass %, the group 2 element contained in the negative electrode additive is hardly eluted as ions into the negative electrode slurry (dispersion medium), and the shift of the negative electrode slurry to basic property is suppressed. Further, since the group 2 element is likely to present as an oxide in the negative electrode slurry, the effect of absorbing hydrogen fluoride is sufficiently obtained.

The content of the group 2 element oxide in the negative electrode additive (mass ratio to the total amount of the negative electrode additive) can be determined by the following method.

The battery is disassembled and the negative electrode is taken out therefrom and washed with a non-aqueous solvent such as ethylene carbonate, dried, and then cross-sectional processing of the negative electrode mixture layer is performed by a cross-section polisher (CP) to obtain a sample. Field emission scanning electron microscopy (FE-SEM) is used to obtain reflected electron images of a cross section of the sample to observe the cross section of the negative electrode additive particle. Using an auger electron spectroscopy (AES) analyzer, a qualitative and quantitative analysis of the elements is performed on a certain region of the central section of the observed cross section of the negative electrode additive particle, and the mass of the group 2 element M is determined (acceleration voltage 10 kV, beam current 10 nA). Assuming that all of the group 2 element M is an oxide MO, the amount of M obtained in the above analysis is converted into an amount of MO. Analyses are performed on the observed 10 negative electrode additive particles, and the average value of the calculated MO amount is taken as the mass W₁ of the group 2 element oxide.

In the above analysis, the mass of other elements Q (Si, alkali metal elements such as Na, Al, etc.) other than the group 2 element M is also determined together with the mass of the group 2 element M. Assuming that all of the element Q form an oxide of the element Q (e.g., SiO₂, Na₂O, Al₂O₃), the mass of the element Q is converted into the mass of the oxide of the element Q. Analyses are performed on the observed 10 negative electrode additive particles, and the average value of the calculated mass of the oxide of the element Q is defined as the mass W₂ of the oxide of the element Q. The sum of W₁ and W₂ is the total amount W₀ of the negative electrode additive. As the content of the group 2 element oxide in the negative electrode additive, (W₁/W₀)×100 is calculated (mass ratio to the total amount of the negative electrode additive).

Note that the average particle size (about 0.3 μm or more and about 3 μm or less) of the negative electrode additive particles is smaller than the average particle size (about 5 μm or more and about 10 μm or less) of the particles of the silicon containing material (SiOₓ and LSX described later), and silicon particles are dispersed inside the particles of the silicon containing material. Observations of the particle size and particle interior allow differentiation between the negative electrode additive particles and the silicon containing material. That is, the negative electrode additive may be silicate particles or glass particles that do not contain silicon particles. In the cross-sectional observation and analysis of the above sample, a carbon sample stage may be used for fixing the sample in order to prevent diffusion of Li. In order not to alter the sample cross section, a transfer vessel capable of holding and transporting the sample without exposing the sample to air may be used.

The content of the sum of silicon dioxide and the group 2 element oxide in the negative electrode additive is, for example, 80 mass % or more, and may be 85 mass % or more, relative to the total amount of the negative electrode additive. In the negative electrode additive, the mass ratio of the group 2 element oxide to silicon dioxide is, for example, ⅓ or more and 50 or less.

The group 2 element oxide preferably contains at least one selected from the group consisting of BaO and CaO. In this case, the effect of collecting hydrogen fluoride is remarkably obtained, and the cycle characteristics are further improved.

The negative electrode additive may further include an alkali-metal element oxide. Also, the negative electrode additive may further include other components such as Al₂O₃, B₂O₃, P₂O₅, and the like. The alkali-metal element oxide may include at least one selected from the group consisting of Li₂O, Na₂O and K₂O. Among them, the alkali-metal element oxide is preferably Na₂O.

When the negative electrode additive further includes Na₂O, cycle characteristics are more likely to be improved. In this case, Na is easily eluted from the negative electrode additive into the liquid electrolyte. When Na is eluted from the negative electrode additive, the negative electrode additive becomes highly reactive and easily reacts with hydrogen fluoride to form fluoride. Therefore, the dissolution deterioration of the silicon containing material due to hydrogen fluoride is more effectively suppressed. Further, Na eluted from the negative electrode additive can be a constituent component of the SEI (Solid Electrolyte Interphase) film formed on the surface of the negative electrode active material when charging and discharging. The resistance of the SEI film containing Na together with Li tends to be small as compared with the SEI film of Li alone. From the above, it is presumed that the cycle characteristics are more easily improved.

The content of the negative electrode additive in the negative electrode mixture may be less than 8 mass %, preferably 7 mass % or less, more preferably 0.3 mass % or more and 7 mass % or less, and still more preferably 0.4 mass % or more and 2 mass % or less relative to the total amount of the negative electrode mixture (100 mass %). When the content of the negative electrode additive in the negative electrode mixture is 0.3 mass % or more relative to the total amount of the negative electrode mixture, the effect of collecting hydrogen fluoride is easily obtained. When the content of the negative electrode additive in the negative electrode mixture is 7 mass % or less relative to the total amount of the negative electrode mixture, the effect of collecting hydrogen fluoride and the effect of suppressing the shift of the negative electrode slurry to basic property are easily obtained in a balanced manner.

The content of the negative electrode additive in the negative electrode mixture (the amount relative to the total amount of the negative electrode mixture) can be determined by the following method. For example, the negative electrode additive may be separated from the negative electrode mixture sample having a known mass, and the mass thereof may be determined, and a ratio occupied thereby in the negative electrode mixture sample may be determined. From the negative electrode mixture, the negative electrode additive particles, or a mixture of the negative electrode additive particles and the silicon containing material particles can be separated in a known manner.

As in the case of determining the content of the group 2 element oxide in the above-mentioned negative electrode additive, the mass ratio of the negative electrode additive particles and the silicon containing material particles may be determined using a cross-sectional image (reflected electron image or the like) of the sample. By observing the particle size and the interior of the particle, the negative electrode additive particles and the silicon containing material particles are distinguished, and the area ratio of the negative electrode additive particles and the silicon containing material particles is determined. The composition of the negative electrode additive is determined by AES analysis. As for silicon containing materials, the composition of the matrix phase is determined by AES analysis, and the content of silicon particles dispersed in the matrix phase is determined by Si-NMR. The specific gravity of each material is determined from the composition. Based on the respective values obtained above, the content of the negative electrode additive in the negative electrode mixture is determined. Note that the area ratio of negative electrode additive particles and the silicon containing material particles may be regarded as a volume ratio.

### (Acrylic Resin)

The acrylic resin contains at least a (meth)acrylic acid salt unit. In this specification, “(meth)acrylic acid” means at least one selected from the group consisting of “acrylic acid” and “methacrylic acid”. In the negative electrode slurry, the acrylic resin may include both units of (meth)acrylic acid and units of (meth)acrylic acid salt. The (Meth)acrylic acid is a weak acid, and (meth)acrylic acid salt is a salt of a weak acid. Therefore, the acrylic resin may exert a buffering action on the negative electrode additive which is basic. Thus, shifting of the negative electrode slurry to basic property by the negative electrode additive is suppressed. The acrylic resin can also serve as a binder in the negative electrode mixture.

Among the carboxyl groups contained in the acrylic resin, a ratio at which a hydrogen atom of the carboxyl group is substituted with an alkali-metal atom or the like (hereinafter, referred to as a substitution ratio) is preferably 70% or more and 80% or less, and more preferably 90% or more. When an acrylic resin having a substitution ratio in the above range is contained in the negative electrode slurry, a buffering action by the acrylic resin tends to work, and a shift of the negative electrode slurry to basic property by the negative electrode additive is efficiently suppressed. Also, the negative electrode slurry is easy to prepare, which is advantageous for improving battery properties.

Examples of the (meth)acrylic acid salt include an alkali-metal salt such as a lithium salt and a sodium salt, an ammonium salt, and the like. Among them, from the viewpoint of reducing internal resistance and the like, a (meth)acrylic acid lithium salt is preferred, and an acrylic acid lithium salt is more preferred.

More specifically, the acrylic resin is a polymer containing at least a (meth)acrylic acid salt unit, among (meth)acrylic acid units and (meth)acrylic acid salt units. The polymer may include at least only (meta)acrylic acid salt units, among a (meta)acrylic acid unit and a (meta)acrylic acid salt unit as repeating units. The polymer may further include other units than units of (meth)acrylic acid and (meth)acrylic acid salt. Examples of the other unit include an ethylene unit and the like. In the polymer, the total of (meth)acrylic acid unit and (meth)acrylic acid salt unit is preferably, for example, 50 mol % or more, and more preferably 80 mol % or more.

Specific examples of the acrylic resin include a salt (having the substitution ratio of 90% or more) of polyacrylic acid, polymethacrylic acid, a copolymer containing repeating units of acrylic acid and/or methacrylic acid (acrylic acid-methacrylic acid copolymer, ethylene-acrylic acid copolymer, etc.). These may be used singly or in combination of two or more.

The weight average molecular weight of the acrylic resin is preferably 3000 or more and 10,000,000 or less. When the weight-average molecular weight of the acrylic resin is within the above range, the effect of improving the cycle characteristics and the effect of reducing the internal resistance by the acrylic resin are sufficiently obtained, and further, gelation (increase in viscosity) of the negative electrode slurry is suppressed, so that it is easy to prepare a negative electrode.

The content of the acrylic resin in the negative electrode mixture may be 0.2 parts by mass or more and 2 parts by mass or less, or 0.4 parts by mass or more and 1.5 parts by mass or less, per 100 parts by mass of the negative electrode active material. When the content of the acrylic resin in the negative electrode mixture is 0.2 parts by mass or more per 100 parts by mass of the negative electrode active material, the effect of suppressing the shift of the negative electrode mixture to basic property is sufficiently obtained. When the content of the acrylic resin in the negative electrode mixture is 2 parts by mass or less per 100 parts by mass of the negative electrode active material, an increase in contact resistance between negative electrode active material particles and between negative electrode active material particles (negative electrode mixture layer) and a negative electrode current collector accompanying repeated charging and discharging is suppressed. Further, it is possible to reduce the viscosity of the negative electrode slurry, and it is easy to prepare a negative electrode slurry. Also, the amount of the negative electrode active material is sufficiently secured, and it is easy to increase the capacity.

### (Negative Electrode Active Material)

The negative electrode active material includes a silicon containing material capable of electrochemically absorbing and releasing lithium ions. Silicon containing materials are advantageous for increasing capacity of batteries.

### (First Composite Material)

The silicon containing material may be a first composite material, and the first composite material includes a silicate phase containing at least one selected from the group consisting of an alkali-metal element and a group 2 element, and silicon particles dispersed in the silicate phase. The control of the amount of the silicon particles dispersed in the silicate phase enables further enhancement of the capacity. Since the silicon particles are dispersed in the silicate phase, expansion and contraction of the first composite material during charging and discharging is suppressed. Thus, the first composite material is advantageous for increasing the capacity of the battery and improving the cycle characteristics.

Hereinafter, the first composite material will be described in detail.

### (Silicon Particles)

From the viewpoint of suppressing cracking of silicon particles, the average particle size of the silicon particles is preferably 500 nm or less, more preferably 200 nm or less, and still more preferably 50 nm or less, before the first charge. After the first charge, the average particle size of the silicon particles is preferably 400 nm or less, more preferably 100 nm or less. By refining the silicon particles, the volume change during charging and discharging becomes small, and the structural stability of the first composite material is further improved.

The average particle size of the silicon particles is measured by observing a cross-sectional SEM (scanning electron microscope) photograph of the first composite material. Specifically, the average particle size of the silicon particles is determined by averaging the maximum diameter of arbitrary selected 100 silicon particles.

From the viewpoint of increasing the capacity, the content of the silicon particles in the first composite material is preferably 30 mass % or more, more preferably 35 mass % or more, and still more preferably 55 mass % or more. In this case, the diffusivity of lithium ions is satisfactory, and excellent loading characteristics can be easily obtained. On the other hand, from the viewpoint of improving the cycle characteristics, the content of the silicon particles in the first composite material is preferably 80 mass % or less, and more preferably 70 mass % or less. In this case, the surface of the silicon particles exposed without being covered with the silicate phase is reduced, and the reaction between the electrolyte and the silicon particles tends to be suppressed.

The content of the silicon particles can be measured by Si-NMR. Desirable measuring conditions for Si-NMR are shown below.

Measuring device: solid-state nuclear magnetic resonance spectrum measuring device (INOVA-400), manufactured by Varian Co., Ltd.

Probing: Varian 7 mm CPMAS-2

MAS: 4.2 kHz

MAS speed: 4 kHz

Pulse: DD (45° pulse+signal capture time 1H decouple)

Repeat time: 1200 sec

Observation width: 100 kHz

Observation center: around −100 ppm

Signal uptake time: 0.05 sec

Accumulated number: 560

Sample Quantity: 207.6 mg

The silicon particles dispersed in the silicate phase have a particulate phase of silicon (Si) simple substance and are composed of one or more crystallites. The crystallite size of the silicon particles is preferably 30 nm or less. When the crystallite size of the silicon particles is 30 nm or less, the amount of change in volume due to expansion and contraction of the silicon particles accompanying charging and discharging can be reduced, and the cycle characteristics are further enhanced. For example, voids are hardly formed around the silicon particles during contraction of the silicon particles, and isolation of the particles due to decrease in contact with the surrounding of the particles is suppressed, and decrease in charge and discharge efficiency due to such isolation is suppressed. The lower limit value of the crystallite size of the silicon particles is not particularly limited, but is, for example, 5 nm or more.

Further, the crystallite size of the silicon particles is more preferably 10 nm or more and 30 nm or less, and still more preferably 15 nm or more and 25 nm or less. When the crystallite size of the silicon particles is 10 nm or more, since the surface area of the silicon particles can be suppressed to be small, deterioration of the silicon particles accompanied by formation of an irreversible capacity is hard to be caused. The crystallite size of the silicon particles is calculated from the half-width of the diffraction peak assigned to the Si (111) plane of the X-ray diffraction (XRD) pattern of the silicon particles by the equation of Sheller.

### (Silicate Phase)

The silicate phase includes at least one of an alkali-metal element (a group 1 element other than hydrogen in the long period type periodic table) and a group 2 element in the long period type periodic table. The alkali-metal element includes lithium (Li), potassium (K), sodium (Na), and the like. The group 2 elements include magnesium (Mg), calcium (Ca), strontium (Sr), barium (Ba), and the like. The silicate phase includes at least one element of an alkali-metal element and a group 2 element, silicon (Si) and oxygen (O). The silicate phase may include aluminum (Al), boron (B), lanthanum (La), phosphorus (P), zirconium (Zr), titanium (Ti), iron (Fe), chromium (Cr), nickel (Ni), manganese (Mn), copper (Cu), molybdenum (Mo), zinc (Zn), and the like as other elements.

Since the irreversible capacity is small and the initial charge and discharge efficiency becomes high, the silicate phase is preferably a silicate phase containing lithium (hereinafter, also referred to as a lithium silicate phase). In other words, it is preferable that the first composite material is a composite material containing a lithium silicate phase and silicon particles dispersed in the lithium silicate phase (hereinafter, also referred to as LSX or negative electrode material LSX). The lithium silicate phase includes at least lithium (Li), silicon (Si) and oxygen (O). Atomic ratio of O to Si in the lithium silicate phase: O/Si is, for example, greater than 2 and less than 4. When O/Si is more than 2 and less than 4 (z is 0<z<2 in the formula described later), it is advantageous in terms of stability and lithium-ion conductivity. Preferably, O/Si is more than 2 and less than 3 (z in the formula described later is 0<z<1). Atomic ratio of Li to Si in the lithium silicate phase: Li/Si is, for example, greater than 0 and less than 4. The lithium silicate phase may include other elements as described above in addition to Li, Si and O.

The lithium silicate phase may have, for example, a composition represented by the formula: Li_{2z}SiO_{2+z} (0<z<2). From the viewpoint of stability, ease of fabrication, lithium-ion conductivity, and the like, z preferably satisfies a relationship of 0<z<1, and more preferably z=½.

The lithium silicate phase of LSX has less sites that can react with lithium compared to SiO₂ phase of SiOₓ. Therefore, LSX is less likely to produce irreversible capacity due to charge and discharge than SiOₓ. When silicon particles are dispersed in a lithium silicate phase, excellent charge and discharge efficiency is obtained at an initial stage of charge and discharge. Further, since the content of silicon particles can be arbitrarily changed, a high-capacity negative electrode can be designed.

The composition of the lithium silicate phase of negative electrode material LSX can be analyzed, for example, by the following method.

The battery is disassembled, negative electrode is taken out, washed with a non-aqueous solvent such as ethylene carbonate, and dried, and then cross-sectional processing of the negative electrode mixture layer is performed by a cross-section polisher (CP) to obtain a sample. Field emission scanning electron microscopy (FE-SEM) is used to obtain a reflected electron image of a cross section of the sample to observe the cross section of the LSX particles. Quantitative analysis of the elements is performed on the observed lithium silicate phase of LSX particles using Auger electron spectroscopy (AES) analyzer (acceleration voltage 10 kV, beam current 10 nA). Based on the content of the obtained lithium (Li), silicon (Si), oxygen (O) and other elements, the composition of the lithium silicate phase is determined.

Note that the average particle size of the LSX particles (about 5 μm or more and about 10 μm or less) is larger than the average particle size of the negative electrode additive particles (0.3 μm or more and about 3 μm or less), and silicon particles are dispersed inside the LSX particles. Therefore, by observing the particle size and the interior of the particle, it is possible to distinguish between the LSX particles and the negative electrode additive particles. In the cross-sectional observation and analysis of the above sample, a carbon sample stage may be used for fixing the sample in order to prevent diffusion of Li. In order not to alter the sample cross section, a transfer vessel capable of holding and transporting the sample without exposing the sample to air may be used.

The first composite material preferably forms a particulate material (hereinafter, also referred to as first particles) and has an average particle size of 5 μm or more and 25 μm or less, or 7 μm or more and 15 μm or less. Within the above particle size range, the stress due to the volume change of the first composite material due to charging and discharging is easily relaxed, and it is easy to obtain good cycle characteristics. The surface area of the first particles is also moderate, and the capacity reduction due to side reaction with electrolyte is also suppressed.

The average particle size of the first particles means the particle size at which cumulative volume is 50% in the particle size distribution measured by the laser diffraction scattering method (volume average particle size). For example, “LA-750” manufactured by Horiba Co., Ltd. (HORIBA) can be used as the measuring device.

Preferably, the first particle comprises a conductive material that coats at least a portion of its surface. Since the silicate phase has poor electron conductivity, the conductivity of the first particle tends to be low. By coating the surface with a conductive material, it is possible to dramatically increase the conductivity. The conductive layer is preferably thin so as not to substantially affect the average particle size of the first particle.

### (Second Composite Material)

The silicon containing material may be a second composite material including a SiO₂ phase and silicon particles dispersed within the SiO₂ phase. The second composite material is represented by SiOₓ and satisfies 0<x<2. Here, x may be 0.5 or more and 1.5 or less. The second composite material is advantageous in that the expansion at the time of charging is small.

### (Carbon Material)

The negative electrode active material may further include a carbon material that electrochemically absorbs and releases lithium ions. The carbon material has a smaller degree of expansion and contraction during charging and discharging than the silicon containing material. By using the silicon containing material and the carbon material in combination, it is possible to maintain the better contact state between the negative electrode active material particles and between the negative electrode mixture layer and the negative electrode current collector during repeated charging and discharging. In other words, it is possible to enhance the cycle characteristics while imparting a high capacity of the silicon containing material to the negative electrode. From the viewpoint of increasing the capacity and improving the cycle characteristics, the occupation ratio of the carbon material in the total of the silicon containing material and the carbon material is preferably 98 mass % or less, more preferably 70 mass % or more and 98 mass % or less, and still more preferably 75 mass % or more and 95 mass % or less.

Examples of the carbon material used as the negative electrode active material include graphite, easily graphitized carbon (soft carbon), hardly graphitized carbon (hard carbon), and the like. Preferred among them is graphite, which is excellent in stability during charging and discharging and has small irreversible capacity. Graphite means a material having a graphite-type crystal structure, examples of which include natural graphite, artificial graphite, graphitized mesophase carbon particles. The carbon material may be used singly or in combination of two or more.

### (Non-Aqueous Electrolyte Secondary Battery)

Further, a non-aqueous electrolyte secondary battery according to an embodiment of the present invention includes a positive electrode, a negative electrode and a non-aqueous electrolyte, and the negative electrode includes the above-described negative electrode mixture.

Hereinafter, a non-aqueous electrolyte secondary battery will be described in detail.

### [Negative Electrode]

A negative electrode may include a negative electrode current collector and a negative electrode mixture layer supported on a surface of the negative electrode current collector. The negative electrode mixture layer can be formed by dispersing a negative electrode mixture containing a silicon containing material, a negative electrode additive, and an acrylic resin in water to prepare a negative electrode slurry, applying the negative electrode slurry to the surface of the negative electrode current collector, and drying the mixture. By including an acrylic resin in the negative electrode mixture (negative electrode slurry), shifting of the negative electrode slurry to basic property by the negative electrode additive is suppressed. The dry applied film may be rolled, if necessary. The negative electrode mixture layer may be formed on one surface of the negative electrode current collector, or on both surfaces thereof

The negative electrode mixture contains a negative electrode active material, a negative electrode additive and an acrylic resin as essential components. The negative electrode mixture may contain, as an optional component, a binder other than the acrylic resin, a conductive agent, a thickener, or the like. The negative electrode active material includes at least a silicon containing material and may further include a carbon material.

As the negative electrode current collector, a non-porous conductive substrate (metal foil, etc.), a porous conductive substrate (mesh-body, net-body, punched sheet, etc.), or the like is used. As the material of the negative electrode current collector, stainless steel, nickel, nickel alloy, copper, copper alloy, or the like can be exemplified. The thickness of the negative electrode current collector is not particularly limited, but is preferably from 1 to 50 μm, more preferably from 5 to 20 μm, from the viewpoint of balancing the strength of the negative electrode and the weight reduction.

Examples of the binder other than the acrylic resin include fluororesins such as polytetrafluoroethylene and polyvinylidene fluoride (PVDF); polyolefin resins such as polyethylene and polypropylene; polyamide resins such as aramid resins; polyimide resins such as polyimide and polyamideimide; acrylic resins such as polyacrylic acid, polymethylacrylate, and ethylene-acrylic acid copolymers; vinyl resins such as polyacrylonitrile and polyvinyl acetate; polyvinylpyrrolidone; polyethersulfone; rubbery materials such as styrene-butadiene copolymer rubber (SBR), and the like. The binder other than the acrylic resin may be used singly, or two or more kinds thereof may be used in combination.

Examples of the conductive agent include carbons such as acetylene black and carbon nanotubes; conductive fibers such as carbon fibers and metal fibers; carbon fluoride; metal powders such as aluminum; conductive whiskers such as zinc oxide and potassium titanate; conductive metal oxides such as titanium oxide; organic conductive materials such as phenylene derivatives, and the like. The conductive agent may be used singly, or two or more kinds thereof may be used in combination.

Examples of the thickener include carboxy methylcellulose (CMC) and a modified product thereof (also including salts such as Na salts), a cellulose derivative such as methylcellulose (such as cellulose ether), a saponified product of a polymer having a vinyl acetate unit such as polyvinyl alcohol, and a polyether (such as polyalkylene oxide such as polyethylene oxide). The thickener may be used singly, or two or more kinds thereof may be used in combination.

As a dispersion medium of the negative electrode slurry, a polar dispersion medium can be used, and for example, water, an alcohol such as ethanol, an ether such as tetrahydrofuran, an amide such as dimethylformamide, or a N-methyl-2-pyrrolidone (NMP) can be used. The dispersion medium may be used singly, or two or more kinds thereof may be used in combination.

### [Positive Electrode]

A positive electrode may include, for example, a positive electrode current collector and a positive electrode mixture layer formed on a surface of the positive electrode current collector. The positive electrode mixture layer can be formed by applying a positive electrode slurry including a positive electrode mixture dispersed in a dispersion medium, onto the surface of the positive electrode current collector, and drying the slurry. The dry applied film may be rolled, if necessary. The positive electrode mixture layer may be formed on one surface of the positive electrode current collector, and may be formed on both surfaces. The positive electrode mixture contains a positive electrode active material as an essential component, and as an optional component, a binder, a conductive agent, or the like can be included. As the dispersion medium of the positive electrode slurry, those exemplified in the negative electrode slurry can be used.

As the positive electrode active material, for example, a lithium-containing composite oxide can be used. For example, LiₐCoO₂, LiₐNiO₂, LiₐMnO₂, LiₐCo_{b}Ni_{1-b}O₂, LiₐCo_{b}M_{1-b}O_{c}, LiₐNi_{1-b}M_{b}O_{c}, LiₐMn₂O₄, LiₐMn_{2-b}M_{b}O₄, LiMPO₄, Li₂MPO₄F (M is at least one selected from the group consisting of Na, Mg, Sc, Y, Mn, Fe, Co, Ni, Cu, Zn, Al, Cr, Pb, Sb and B.) can be listed. Here, a=0 to 1.2, b=0 to 0.9, and c=2.0 to 2.3. Note that the value “a” indicating the molar ratio of lithium is increased or decreased by charging and discharging.

Among them, a lithium-nickel composite oxide represented by LiₐNi_{b}M_{1-b}O₂ (M is at least one selected from the group consisting of Mn, Co and Al, 0<a≤1.2, 0.3≤b≤1.) is preferred. From the viewpoint of increasing the capacity, it is more preferable to satisfy 0.85≤b≤1. From the viewpoint of stability of the crystal structure, LiₐNi_{b}Co_{c}Al_{d}O₂ including Co and Al as M (0<a≤1.2, 0.85≤b<1, 0<c<0.15, 0<d≤0.1, b+c+d=1) is more preferred.

As the binder and the conductive agent, those listed to exemplify for the negative electrode can be used. As the binder, an acrylic resin may be used. As the conductive agent, graphite such as natural graphite or artificial graphite may be used.

The shape and thickness of the positive electrode current collector can be selected from the shapes and ranges according to the negative electrode current collector, respectively. As the material of the positive electrode current collector, for example, stainless steel, aluminum, aluminum alloy, titanium, or the like can be exemplified.

### [Non-Aqueous Electrolyte]

The non-aqueous electrolyte includes a non-aqueous solvent and a lithium salt dissolved in the non-aqueous solvent. The concentration of the lithium salt in the non-aqueous electrolyte is preferably, for example, 0.5 mol/L or more and 2 mol/L or less. By setting the lithium salt concentration within the above range, a non-aqueous electrolyte having excellent ion conductivity and moderate viscosity can be obtained. However, the lithium salt concentration is not limited to the above.

Examples of the lithium salt include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, borates, imides, and the like. Examples of the boric acid salts include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzenesulfonic acid-O,O′)borate. Examples of the imide salt include lithium bis(fluorosulfonyl)imide (LFSI), lithium bis(trifluoromethylsulfonyl)imide (LiN(CF₃SO₂)₂), lithium trifluoromethylsulfonyl nonafluorobutylsulfonyl imide (LiN(CF₃SO₂)(C₄F₉SO₂)), lithium bis(pentafluoroethylsulfonyl)imide (LiN(C₂F₅SO₂)₂), and the like. Among these, LiPF₆ is preferred. LiPF₆ tends to form a passive film on the surface of a member constituting a battery such as an outer can. The member can be protected by the passive film. The lithium salt may be used singly, or two or more kinds thereof may be used in combination.

As the non-aqueous solvent, for example, a cyclic carbonic acid ester, a chain carbonic acid ester, a cyclic carboxylic acid ester, a chain carboxylic acid ester, or the like may be used. Examples of the cyclic carbonic acid ester include propylene carbonate (PC), ethylene carbonate (EC), and the like. Examples of the chain carbonic acid ester include diethyl carbonate (DEC), ethyl methyl carbonate (EMC), dimethyl carbonate (DMC), and the like. Examples of the cyclic carboxylic acid ester include γ-butyrolactone (GBL) and γ-valerolactone (GVL). Examples of the chain carboxylic acid ester include methyl formate, ethyl formate, propyl formate, methyl acetate, ethyl acetate, propyl acetate, methyl propionate, ethyl propionate, and propyl propionate. The non-aqueous solvent may be used singly, or two or more kinds thereof may be used in combination.

### [Separator]

Usually, it is desirable to interpose a separator between the positive electrode and the negative electrode. The separator is excellent in ion permeability and has moderate mechanical strength and electrically insulating property. As the separator, a microporous thin film, a woven fabric, a nonwoven fabric, or the like can be used. As a material of the separator, a polyolefin such as polypropylene or polyethylene is preferred.

In an exemplary structure of the non-aqueous electrolyte secondary battery, an electrode group formed by winding the positive electrode and the negative electrode with the separator interposed therebetween is housed together with the non-aqueous electrolyte in an outer case. Alternatively, other forms of electrode groups may be applied, such as a stack electrode group in which a positive electrode and a negative electrode are laminated via separator, instead of the wound electrode group. Non-aqueous electrolyte secondary batteries may be in any form, for example, in cylindrical, square, coin-shaped, button-shaped, laminated, or the like.

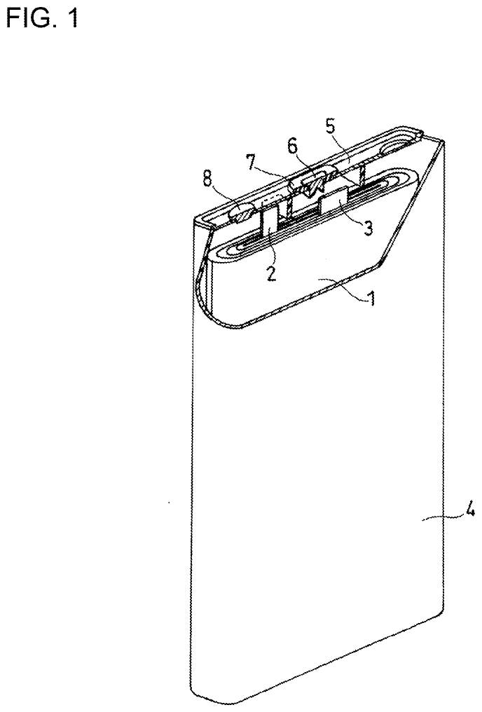

Hereinafter, a square non-aqueous electrolyte secondary battery as an example of a non-aqueous electrolyte secondary battery according to the present invention is described referring to FIG. 1. FIG. 1 is a schematic partially cut-away oblique view of a non-aqueous electrolyte secondary battery according to an embodiment of the present invention.

The battery includes a bottomed prismatic battery case 4, and an electrode group 1 and a liquid electrolyte (not shown) housed in the battery case 4. The electrode group 1 has a long strip-like negative electrode, a long strip-like positive electrode and a separator interposed and preventing direct contact therebetween. The electrode group 1 is formed by winding the negative electrode, the positive electrode and the separator around a flat core and removing the winding core.

One end of the negative electrode lead 3 is attached to the negative electrode current collector of the negative electrode by welding or the like. The other end of the negative electrode lead 3 is electrically connected to the negative electrode terminal 6 provided on the sealing plate 5 via an insulating plate made of resin (not shown). The negative electrode terminal 6 is insulated from the sealing plate 5 by a resin-made gasket 7. One end of the positive electrode lead 2 is attached to the positive electrode current collector of the positive electrode by welding or the like. The other end of the positive electrode lead 2 is connected to the rear surface of the sealing plate 5 via an insulating plate. That is, the positive electrode lead 2 is electrically connected to the battery case 4 serving as the positive electrode terminal. The insulating plate separates the electrode group 1 and the sealing plate 5 and separates the negative electrode lead 3 and the battery case 4. The periphery of the sealing plate 5 is fitted to the open end of the battery case 4, and the fitting portion is laser welded. In this way, the opening of the battery case 4 is sealed with the sealing plate 5. The injection hole of the electrolyte provided in the sealing plate 5 is closed by the sealing plug 8.

### EXAMPLES

Hereinafter, examples of the present invention will be specifically described, but the present invention is not limited to the following examples.

### Example 1

### Preparation of Negative Electrode

After adding water to a negative electrode mixture, the mixture was stirred using a mixer (manufactured by PRIMIX Co., Ltd., T. K. HIVIS MIX) to prepare a negative electrode slurry. As the negative electrode mixture, a mixture of a negative electrode active material, a negative electrode additive, a lithium salt of polyacrylic acid (PAA-Li), a sodium salt of carboxy methylcellulose (CMC-Na) and a styrene-butadiene rubber (SBR) was used.

As the negative electrode active material, a mixture of a silicon containing material and graphite was used. The occupation ratio of the graphite in the total of the silicon containing material and the graphite was set to 95 mass %. Particles of SiO (x=1) (average particle size 5 to 10 μm) were used as the second composite material for the silicon containing material.

As the negative electrode additive, a powdery glass (average particle size: 1 μm) containing silicon dioxide (SiO₂), Li₂O which is an alkali-metal element oxide, and CaO which is a group 2 element oxide was used. The content of SiO₂, Li₂O and CaO in the negative electrode additive was set to 74.4 mass %, 8.2 mass % and 17.4 mass %, respectively. “Bal.” as the SiO₂ content in Tables 1 to 3 indicates the remaining amount. The content of the negative electrode additive in the negative electrode mixture was set to 0.5 parts by mass per 100 parts by mass of the negative electrode active material.

As for PAA-Li, one having a substitution ratio of 100% were used. The content of PAA-Li in the negative electrode mixture was set to 0.7 parts by mass per 100 parts by mass of the negative electrode active material. The content of CMC-Na in the negative electrode mixture was set to 1 parts by mass per 100 parts by mass of the negative electrode active material. The content of SBR in the negative electrode mixture was set to 1 parts by mass per 100 parts by mass of the negative electrode active material.

Next, a negative electrode slurry was applied to the surface of the copper foil so that the mass of negative electrode mixture per 1 m² was 190 g, and the coating film was dried, and then rolled to form a negative electrode mixture layer having a density of 1.5 g/cm³ on both surfaces of the copper foil to obtain a negative electrode.

### Preparation of Positive Electrode

A positive electrode slurry was prepared by mixing a lithium nickel composite oxide (LiNi_{0.8}Co_{0.18}Al_{0.02}O₂), acetylene black and polyvinylidene fluoride in a weight ratio of 95:2.5:2.5, adding N-methyl-2-pyrrolidone (NMP) thereto, and stirring the mixture using a mixer (PRIMIX Co., Ltd., T. K. HIVIS MIX). Next, the positive electrode slurry was applied to the surface of an aluminum foil, and the coating film was dried, and then rolled to form a positive electrode mixture layer having a density of 3.6 g/cm³ on both surfaces of the aluminum foil to obtain a positive electrode.

### Preparation of Non-Aqueous Electrolyte

A non-aqueous electrolyte was prepared by dissolving a lithium salt in a non-aqueous solvent. As the non-aqueous solvent, a solvent obtained by mixing ethylene carbonate (EC) and dimethyl carbonate (DMC) in a volume ratio of 3:7 was used. LiPF₆ was used for the lithium salt. The concentration of LiPF₆ in the non-aqueous electrolyte was set as 1.0 mol/L.

### Preparation of Non-Aqueous Electrolyte Secondary Battery

A tab was attached to each electrode, respectively, and an electrode group was manufactured by winding the positive electrode and the negative electrode in a spiral shape via a separator so that a tab was located at an outermost peripheral portion. The electrode group was inserted into an exterior material made of an aluminum laminate film, dried under vacuum at 105° C. for 2 hours, and then the non-aqueous electrolyte was injected thereinto and the opening of the exterior material was sealed to obtain Battery A1.

The negative electrode slurry and the battery prepared above were evaluated as follows.

### [Evaluation 1: pH of Negative Electrode Slurry]

The negative electrode slurry used in Battery A1 was prepared, and the pH of the negative electrode slurry at 25° C. was measured.

### [Evaluation 2: Capacity Retention Ratio at 150 Cycles]

As to Battery A1, a constant current charge was performed until the voltage became 4.2 V at a current of 0.3 It (990 mA), then constant voltage charge was performed until the current became 0.015 It (50 mA) at a constant voltage of 4.2V. Thereafter, a constant current discharge was performed until the voltage became 2.75 V at a current of 0.3 It (990 mA). The rest time between charging and discharging was 10 minutes. Charge and discharge were carried out under an environment of 25° C.

Charging and discharging were repeated under the above conditions. The ratio of the discharge capacity of the 150th cycle to the discharge capacity of the first cycle was determined as the capacity retention ratio. The capacity retention ratio was expressed as an index obtained by setting the capacity retention ratio of Battery B1 as 100.

### Example 2

Batteries A2 to A6 were prepared in the same manner as in Battery A1, except that the content of each component in the negative electrode additive was set to the value shown in Table 1. Note that the content of each component in the negative electrode additive in Table 1 is a mass ratio (mass %) relative to the total amount of the negative electrode additive. In addition, in Table 1, Li₂O and Na₂O are alkali-metal element oxides, and BaO, CaO and MgO are group 2 element oxides.

### Comparative Example 1

Battery B1 was manufactured in the same manner as in Battery A1, except that no negative electrode additive and PAA-Li were contained in the negative electrode mixture. Battery B2 was manufactured in the same manner as in Battery A1 except that no PAA-Li was contained in the negative electrode mixture. Battery B3 was manufactured in the same manner as in Battery A1, except that no negative electrode additive was contained in the negative electrode mixture. Batteries B4 to B5 were prepared in the same manner as in Battery A1, except that the content of each component in the negative electrode additive was set to the value shown in Table 1. Batteries B1 to B5 were evaluated in the same manner as Battery A1.

The evaluation results of Batteries A1 to A6 and B1 to B5 are shown in Table 1.

TABLE 1

| | Negative electrode | | | | | | | | | | | | | | |
|---|---|---|---|---|---|---|---|---|---|---|---|---|---|---|---|
| | Negative electrode | | | | | | | | | | | | | | |
| | active material | | | | Negative | | | | | | | | | | |
| | | Silicon | | | electrode | | | | | | | | | Evaluation | |
| | | containing | | PAA-Li | additive | Component of negative electrode additive | | | | | | | | Negative | Capacity |
| | Graphite | material | | content | content | content | | | | | | | | electrode | retention |
| Battery | content | | Content | (parts by | (parts by | (mass %) | | | | | | | | slurry | ratio |
| No. | (mass %) | Type | (mass %) | mass) | mass) | SiO₂ | Li₂O | Na₂O | BaO | CaO | MgO | Al₂O₃ | P₂O₅ | pH | (Index) |
| B1 | 95 | SiO | 5 | — | — | — | — | — | — | — | — | — | — | 8.5 | 100 |
| B2 | 95 | SiO | 5 | — | 0.5 | Bal. | 8.2 | — | — | 17.4 | — | — | — | 10.0 | 102 |
| B3 | 95 | SiO | 5 | 0.7 | — | — | — | — | — | — | — | — | — | 8.1 | 103 |
| B4 | 95 | SiO | 5 | 0.7 | 0.5 | Bal. | 0.5 | — | — | 31.0 | — | 3.2 | 11.2 | 9.3 | 110 |
| A1 | 95 | SiO | 5 | 0.7 | 0.5 | Bal. | 8.2 | — | — | 17.4 | — | — | — | 8.6 | 125 |
| A2 | 95 | SiO | 5 | 0.7 | 0.5 | Bal. | 7.5 | — | — | 15.9 | — | 3.4 | 11.9 | 9.1 | 122 |
| A3 | 95 | SiO | 5 | 0.7 | 0.5 | Bal. | 8.2 | — | — | 10.2 | — | — | — | 8.6 | 120 |
| A4 | 95 | SiO | 5 | 0.7 | 0.5 | Bal. | 8.1 | — | — | 5.1 | — | — | — | 8.5 | 117 |
| A5 | 95 | SiO | 5 | 0.7 | 0.5 | Bal. | 8.1 | — | — | 3.0 | — | — | — | 8.2 | 116 |
| B5 | 95 | SiO | 5 | 0.7 | 0.5 | Bal. | 1.0 | — | 65.0 | — | — | 2.0 | 2.5 | 9.4 | 109 |
| A6 | 95 | SiO | 5 | 0.7 | 0.5 | Bal. | 7.1 | — | 19.4 | — | — | — | — | 8.5 | 120 |

In Battery A1 in which the content of the group 2 element oxide (CaO) in the negative electrode additive is less than 20 mass % relative to the total amount of the negative electrode additive, a high capacity retention ratio was obtained and the cycle characteristics were greatly improved. In Battery A1, the improvement range of the capacity retention ratio with respect to Battery B1 was very large, which was 25%, and the improvement of the capacity retention ratio with respect to Battery B1 was greatly increased as compared with Battery B4 in which the content of the group 2 element oxide (CaO) in the negative electrode additive was 20 mass % or more relative to the total amount of the negative electrode additive. In Battery B4, the improvement range of the capacity retention ratio relative to Battery B1 was as small as 10%.

In the negative electrode slurry used at the time of manufacturing Battery A1, the pH was lower than that of the negative electrode slurry used at the time of manufacturing Battery B4, and the range of decrease in pH was larger with respect to the negative electrode slurry used at the time of manufacturing Battery B2.

In Battery A6 in which the content of the group 2 element oxide (BaO) in the negative electrode additive was less than 20 mass % relative to the total amount of the negative electrode additive, the improvement in the capacity retention ratio with respect to Battery B1 was greatly increased as compared with Battery B5 in which the content of the group 2 element oxide (BaO) in the negative electrode additive was 20 mass % or more relative to the total amount of the negative electrode additive.

Even in Batteries A2 to A6 in which the content of the group 2 element oxide (CaO) in the negative electrode additive is less than 20 mass % relative to the total amount of the negative electrode additive, the improvement in the capacity retention ratio with respect to Battery B1 were greatly increased as compared with Battery B4 in which the content of the group 2 element oxide (CaO) in the negative electrode additive is 20 mass % or more relative to the total amount of the negative electrode additive. Among them, in Batteries A1 to A3 in which the content of CaO in the negative electrode additive was 10 mass % or more and 19.5 mass % or less relative to the total amount of the negative electrode additive, a high capacity retention ratio of 120 or more was obtained.

Lower capacity retention ratio was obtained in battery B1 in which the negative electrode mixture without PAA-Li and without the negative electrode additive was used. In Battery B2 in which the negative electrode additive was contained in the negative electrode mixture while PAA-Li was not contained, hydrogen fluoride was reduced by the negative electrode additive, but the negative electrode slurry was shifted to basic property to deteriorate the silicon containing material. Therefore, the cycle characteristics were hardly improved. In Battery B3 in which the negative electrode mixture contained PAA-Li while the negative electrode mixture did not contain the negative electrode additive, PAA-Li served as a binder, but the silicon containing material deteriorated due to hydrogen fluoride. Therefore, the cycle characteristics were hardly improved.

In the negative electrode slurry used at the time of manufacturing Battery B2, since the negative electrode additive was contained in the negative electrode mixture, a pH higher than that of the negative electrode slurry used at the time of manufacturing Battery B1 was obtained. In the negative electrode slurries used at the time of manufacturing Batteries A1 to A6, lower pH's were obtained than the negative electrode slurry used at the time of manufacturing Battery B2 because PAA-Li was contained in the negative electrode mixture together with the negative electrode additive.

### Example 3

Batteries A7 to A8 were manufactured and evaluated in the same manner as in Battery A1, except that the content of each component in the negative electrode additive was set to the value shown in Table 2. The evaluation results are shown in Table 2. Note that the content of each component in the negative electrode additive in Table 2 is a mass ratio (mass %) relative to the total amount of the negative electrode additive. In addition, in Table 2, Li₂O and Na₂O are alkali-metal element oxides, and BaO, CaO and MgO are group 2 element oxides.

### Example 4

### Preparation of Negative Electrode Material LSX

Silicon dioxide and lithium carbonate were mixed so that the atomic ratio: Si/Li was 1.05, and the mixture was calcined at 950° C. in air for 10 hours to obtain a lithium silicate represented by Li₂Si₂O₅ (z=½). The obtained lithium silicate was pulverized so as to have an average particle size of 10 μm.

Li₂Si₂O₅ with an average particle size of 10 μm and the raw silicon (3N, average particle size of 10 μm) were mixed in a mass ratio of 45:55. The mixture was put into a pot (made of SUS, volume:500 mL) of a planetary ball mill (P-5 manufactured by Fritsch Co., Ltd.), and 24 balls made of SUS (diameter: 20 mm) were placed in the pot and the lid was closed, and the mixture was ground at 200 rpm for 50 hours in an inert atmosphere.

Next, a powdery mixture was taken out in an inert atmosphere, and the mixture was baked at 800° C. for 4 hours in an inert atmosphere under a state in which pressure by a hot pressing machine was applied to obtain a sintered body (negative electrode material LSX) of the mixture.

Thereafter, the negative electrode material LSX was pulverized and passed through a mesh of 40 and then the obtained LSX particles were mixed with a coal pitch (MCP250 manufactured by JFE Chemical Co., Ltd.), and the mixture was calcined in an inert atmosphere at 800° C., thereby forming a conductive layer containing a conductive carbon on the surface of the LSX particles. Coating amount of the conductive layer was 5 mass % with respect to the total mass of the LSX particles and the conductive layer. Thereafter, using a sieve, LSX particles (average particle size: 5 pin) having a conductive layer were obtained.

The crystallite size of the silicon particles calculated by Sheller's equation from the diffraction peak assigned to the Si(111) plane by XRD analysis of LSX particles was 15 nm. The content of the silicon particles in LSX particles measured by Si-NMR was 55 mass %.

Batteries C1 to C3 were manufactured and evaluated in the same manner as in Batteries A1, A7 and A8, respectively, except for using LSX with the conductive layer obtained above as the silicon containing material as the first composite material. The evaluation results are shown in Table 2.

TABLE 2

| | Negative electrode | | | | | | | | | | | | | | |
|---|---|---|---|---|---|---|---|---|---|---|---|---|---|---|---|
| | Negative electrode | | | | | | | | | | | | | | |
| | active material | | | | Negative | | | | | | | | | | |
| | | Silicon | | | electrode | | | | | | | | | Evaluation | |
| | | containing | | PAA-Li | additive | Component of negative electrode additive | | | | | | | | Negative | Capacity |
| | Graphite | material | | content | content | content | | | | | | | | electrode | retention |
| Battery | content | | Content | (parts by | (parts by | (mass %) | | | | | | | | slurry | ratio |
| No. | (mass %) | Type | (mass %) | mass) | mass) | SiO₂ | Li₂O | Na₂O | BaO | CaO | MgO | Al₂O₃ | P₂O₅ | pH | (Index) |
| A1 | 95 | SiO | 5 | 0.7 | 0.5 | Bal. | 8.2 | — | — | 17.4 | — | — | — | 8.6 | 125 |
| A7 | 95 | SiO | 5 | 0.7 | 0.5 | Bal. | 5.3 | 5.5 | — | 16.9 | — | — | — | 8.4 | 135 |
| A8 | 95 | SiO | 5 | 0.7 | 0.5 | Bal. | — | 15.6 | — | 16.0 | — | — | — | 8.3 | 140 |
| C1 | 95 | LSX | 5 | 0.7 | 0.5 | Bal. | 8.2 | — | — | 17.4 | — | — | — | 8.5 | 145 |
| C2 | 95 | LSX | 5 | 0.7 | 0.5 | Bal. | 5.3 | 5.5 | — | 16.9 | — | — | — | 8.5 | 149 |
| C3 | 95 | LSX | 5 | 0.7 | 0.5 | Bal. | — | 15.6 | — | 16.0 | — | — | — | 8.6 | 148 |

High capacity retention ratio was obtained for each of Batteries A1, A7 and A8. Among them, very high capacity retention ratios of over 135 were obtained for Batteries A7 and A8 with the negative electrode additives including Na₂O.

Batteries C1 to C3 using LSX as the silicon containing material yielded higher capacity retention ratio than Batteries A1, A7 and A8 using SiO as the silicon-containing material. Among them, a very high capacity retention ratio of about 150 was obtained in Batteries C2 and C3 with the negative electrode additives containing Na₂O.

### Example 5

Batteries A9 and A10 were manufactured and evaluated in the same manner as in Battery A1, except that the content of PAA-Li in the negative electrode mixture was set to the values shown in Table 3. Note that the content of PAA-Li in Table 3 is an amount (parts by mass) per 100 parts by mass of the negative electrode active material.

Batteries A11 and A12 were prepared and evaluated in the same manner as in Battery A1, except that the content of the negative electrode additive in the negative electrode mixture was set to the values shown in Table 3. Note that the content of the negative electrode additive in Table 3 is an amount (parts by mass) per 100 parts by mass of the negative electrode active material.

Batteries A9 to A12 were evaluated in the same manner as that of Battery A1. The evaluation results are shown in Table 3.

TABLE 3

| | Negative electrode | | | | | | | | | | | | | | |
|---|---|---|---|---|---|---|---|---|---|---|---|---|---|---|---|
| | Negative electrode | | | | | | | | | | | | | | |
| | active material | | | | Negative | | | | | | | | | | |
| | | Silicon | | | electrode | | | | | | | | | Evaluation | |
| | | containing | | PAA-Li | additive | Component of negative electrode additive | | | | | | | | Negative | Capacity |
| | Graphite | material | | content | content | content | | | | | | | | electrode | retention |
| Battery | content | | Content | (parts by | (parts by | (mass %) | | | | | | | | slurry | ratio |
| No. | (mass %) | Type | (mass %) | mass) | mass) | SiO₂ | Li₂O | Na₂O | BaO | CaO | MgO | Al₂O₃ | P₂O₅ | pH | (Index) |
| A1 | 95 | SiO | 5 | 0.7 | 0.5 | Bal. | 8.2 | — | — | 17.4 | — | — | — | 8.3 | 125 |
| A9 | 95 | SiO | 5 | 0.4 | 0.5 | Bal. | 8.2 | — | — | 17.4 | — | — | — | 8.6 | 120 |
| A10 | 95 | SiO | 5 | 1.5 | 0.5 | Bal. | 8.2 | — | — | 17.4 | — | — | — | 8.0 | 124 |
| A11 | 95 | SiO | 5 | 0.7 | 1.0 | Bal. | 8.2 | — | — | 17.4 | — | — | — | 8.8 | 124 |
| A12 | 95 | SiO | 5 | 0.7 | 2.0 | Bal. | 8.2 | — | — | 17.4 | — | — | — | 8.9 | 125 |

In Batteries A1, A9 and A10 in which the content of PAA-Li in the negative electrode mixture was 0.2 parts by mass or more and 2.0 parts by mass or less per 100 parts by mass of the negative electrode active material, high capacity retention ratios were obtained and cycle characteristics were improved. High capacity retention ratios were obtained in Batteries A1, A11 and A12 in which the content of the negative electrode additive was 0.3 mass % or more and 7 mass % or less relative to the total amount of the negative electrode mixture.

### INDUSTRIAL APPLICABILITY

Non-aqueous electrolyte secondary batteries according to the present invention are useful for a main power supply such as a mobile communication device or a portable electronic device.

While the invention has been described with respect to presently preferred embodiments, such disclosure should not be construed as limiting. Various variations and modifications will certainly become apparent to those skilled in the art belonging to the present invention upon reading the above disclosure. Accordingly, the appended claims are to be construed as encompassing all variations and modifications without departing from the true spirit and scope of the invention.

### REFERENCE SIGNS LIST

1: Electrode group
2: Positive electrode lead
3: Negative electrode lead
4: Battery case
5: Sealing plate
6: Negative electrode terminal
7: Gasket
8: Sealing plug

1. A negative electrode for a non-aqueous electrolyte secondary including:
a negative electrode mixture including a negative electrode active material capable of electrochemically absorbing and releasing lithium ions, a negative electrode additive and an acrylic resin;
the negative electrode active material including a silicon-containing material,
the negative electrode additive including at least silicon dioxide and a group 2 element oxide,
the group 2 element oxide including at least one selected from the group consisting of BeO, MgO, CaO, SrO, BaO and RaO,
the acrylic resin including at least a (meth)acrylic acid salt unit,
the content of the group 2 element oxide in the negative electrode additive being less than 20 mass % relative to a total amount of the negative electrode additive.

2. The negative electrode for a non-aqueous electrolyte secondary battery according to claim 1, wherein the group 2 element oxide includes at least one selected from the group consisting of BaO and CaO.

3. The negative electrode for a non-aqueous electrolyte secondary battery according to claim 1, wherein the negative electrode additive further includes an alkali metal element oxide, the alkali metal element oxide including at least one selected from the group consisting of Li₂O, Na₂O and K₂O.

4. The negative electrode for a non-aqueous electrolyte secondary battery according to claim 3, wherein the alkali metal element oxide includes Na₂O.

5. The negative electrode for a non-aqueous electrolyte secondary battery according to claim 1, wherein a content of the negative electrode additive in the negative electrode mixture is less than 8 mass % relative to a total amount of the negative electrode mixture.

6. The negative electrode for a non-aqueous electrolyte secondary battery according to claim 1, wherein a content of the negative electrode additive in the negative electrode mixture is 0.3 mass % or more and 7 mass % or less relative to a total amount of the negative electrode mixture.

7. The negative electrode for a non-aqueous electrolyte secondary battery according to claim 1, wherein the (meth)acrylic acid salt is a (meth)acrylic acid lithium salt.

8. The negative electrode for a non-aqueous electrolyte secondary battery according to claim 1, wherein a content of the acrylic resin in the negative electrode mixture is 0.2 parts by mass or more and 2 parts by mass or less per 100 parts by mass of the negative electrode active material.

9. The negative electrode for a non-aqueous electrolyte secondary battery according to claim 1, wherein the silicon containing material includes a composite material including a silicate phase and silicon particles dispersed in the silicate phase, and
the silicate phase includes at least one selected from the group consisting of alkali metal elements and group 2 elements.

10. The negative electrode for a non-aqueous electrolyte secondary battery according to claim 1, wherein the negative electrode active material further includes a carbon material.

11. The negative electrode for a non-aqueous electrolyte secondary battery according to claim 1, including a negative electrode current collector and a layer containing the negative electrode mixture supported on a surface of the negative electrode current collector.

12. A non-aqueous electrolyte secondary battery comprising a positive electrode, a negative electrode, and a non-aqueous electrolyte, wherein the negative electrode is the negative electrode according to claim 1.

13. The non-aqueous electrolyte secondary battery according to claim 12, wherein the non-aqueous electrolyte includes LiPF₆.
